(19) United States
(12) Patent Application Publication
(10) Pub. No.: US 2001/0041539 A1
(43) Pub. Date: Nov. 15, 2001

(54) A WIRELESS TERMINAL COMMUNICATION SYSTEM

(76) Inventors: JOUNI JUNTUNEN, OULU (FI); KEIJO LAHETKANGAS, OULU (FI)

Correspondence Address: PERMAN & GREEN, 425 POST ROAD, FAIRFIELD, CT, 064306232

(21) Appl. No.: 09/139,256

(22) Filed: Aug. 25, 1998

(30) Foreign Application Priority Data
Aug. 29, 1997 (GB) 9718370.1

(51) Int. Cl. H04B 17/00; H04M 9/00

(52) U.S. Cl. 455/67.7; 455/67.1

(57) ABSTRACT

A communications system is disclosed which comprises a subscriber terminal (31) and an associated subscriber base unit (30) for providing communication with a telecommunications network via an RF link (32). The terminal (31) for base unit (30) is operable in one mode to signal to a user an indication of the quality of the RF link (32).

### BACKGROUND OF THE INVENTION

The present invention relates to telecommunications terminal equipment. In particular, it relates to terminal equipment for a wireless local loop (WLL) system and the installation of such equipment.

Until recently, wireline loop technologies dominated both existing and planned fixed access networks. Technological advancements have made wireless technology a cost effective alternative for areas where fixed access service is either insufficient or non-existent. Wireless local loop systems are a preferable way to extend telecommunication networks such as the public switch telephone network (PSTN) or integrated services digital network (ISDN) to new subscribers, as the equipment is more economical than copper lines. FIG. 1 of the accompanying drawings shows subscriber's equipment for a wireless local loop. This equipment comprises a wireless local loop terminal 10 or base unit which is powered by the subscriber's power supply 11 and conventional terminal equipment, such as a landline telephone 12. The wireless local loop terminal 10, may accommodate a plurality of subscriber terminals, such as other landline telephones, fax machines, modems, etc.

Whilst wireless local loop networks are cheaper than fixed access networks, and also have installation time savings, they do still involve significant costs and installation time. This is because they require installation of the subscriber equipment to be effected by the network operators using installation specific tools.

FIG. 2 of the accompanying drawings shows typical installation specific tools. The tools comprise a service handset 24 for installing and testing a wireless local loop terminal 21, and a service adaptor 22 which is connected to a terminal connector 23 of the wireless local loop terminal 21 to couple the service handset 24 to the terminal 21.

The optimum location for the fixing of the wireless terminal 21 at the subscriber's premises is determined as follows. If the subscriber has a preferred installation location, then the terminal 21 is moved to that location. The installation handset is used to check the field strength, and its display displays the received signal strength indication. If this indication is at an acceptable level, then the terminal can be fixed at the preferred installation location. Alternatively, if the received signal strength indication is too low, or the subscriber wishes the terminal to be placed where received signal strength is at its highest, then the terminal is moved to another location and the field strength again checked in that position. Once a suitable location has been determined, the adaptor is removed from the connector 23 of the terminal 21, and a cover is placed over the connector 23, to conceal it.

### SUMMARY OF THE INVENTION

According to the present invention there is provided a communications system comprising a subscriber terminal and an associated subscriber base unit for providing communication with a telecommunications network via an RF link, wherein the terminal or base unit is operable, in one mode, to signal to the user an indication of the quality of said RF link.

Such a system reduces installation cost and time. The need for special installation tools is eliminated, as the system is provided with special mode in which the quality of the RF link between that system and the telecommunications network is indicated by the subscriber terminal or base unit.

The indication may be realised by any of the user's senses. For example, the indication may be an acoustic indication (e.g. via a loudspeaker), a visual indication (e.g. by display), a tactile indication (e.g. by vibration of the phone battery). However, preferably the system gives an indication of the quality of the RF link acoustically. This has the advantage that no special type of subscriber terminal is required as the terminal's receiver (e.g. the phone's loudspeaker) can be used to produce the acoustic indication. This is in contrast to a visual indication, where a terminal or base unit would have to have a display. Hence, the cost could be further reduced.

The acoustic indication could be a variation in frequency of an acoustic signal according to the quality of the RF link between the communications system and the telecommunications network. Alternatively, it could, for example, be a variation in the intensity of the acoustic signal depending on the quality of the RF link.

The quality of the path of the RF link from the telecommunications network to the communications system may be determined by the communications system. In addition, the quality of the path of the RF link from the communications system to the telecommunications network may be determined by the telecommunications network. In this case, the results may be sent to the terminal by SMS or another signalling method.

The quality of the path may be determined by measuring the received signal strength and/or the value of the path loss criterion, for example.

The communications system may be arranged such that the network initiates its operation in said one mode, for example whenever the network configuration has changed, (i.e. base stations added, power levels adjusted etc.).

### BRIEF DESCRIPTION OF THE DRAWINGS

Embodiments of the present invention are illustrated, by way of example, with reference to the accompanying drawings of which:

FIG. 1 illustrates wireless local loop terminal equipment;

FIG. 2 illustrates a wireless local loop base unit and conventional installation equipment;

FIG. 3 illustrates wireless local loop terminal equipment according to an embodiment of the present invention; and

FIG. 4 is a flow chart showing an optimum installation procedure according to an embodiment of the present invention.

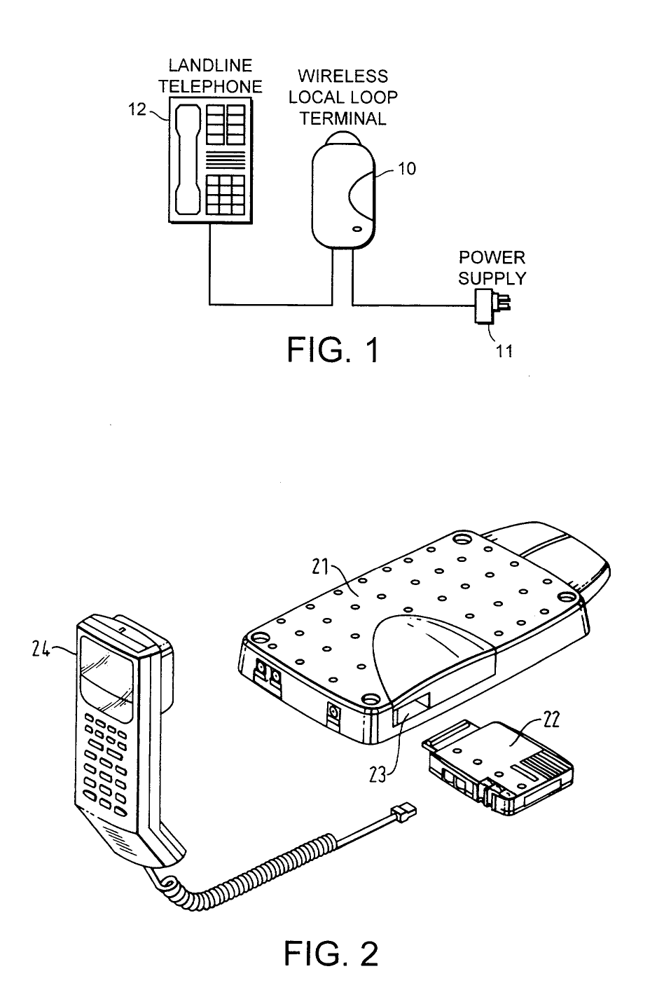

### DETAILED DESCRIPTION OF THE INVENTION

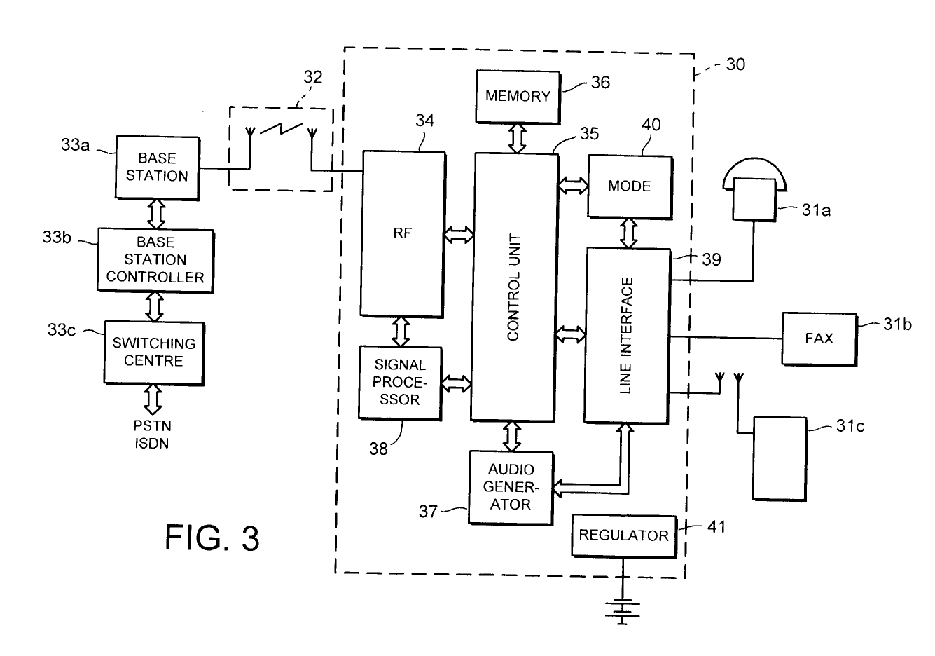

FIG. 3 shows subscriber's wireless local loop terminal equipment according to an embodiment of the present invention, which comprises a subscriber base unit or wireless local loop terminal 30 and a plurality of subscriber terminals 31a to 31c. The subscriber's equipment 30, 31 is coupled to a telecommunications network 33. In this embodiment, it is coupled to a cellular system which comprises base station 33a for transferring data by radio via an antenna to the subscriber's terminal equipment (i.e. via RF link 32). The base stations are connected to base station controller 33b which are further connected to the switching centre 33c. The switching centre 33c is linked to a network such as the public switch telephone network (PSDN) or the integrated services digital network (ISDN).

A subscriber terminal 31 may, for example, be a telephone 31a which may be coupled to the subscriber base unit 30 by a fixed line, a handset 31c which may be coupled to the subscriber base unit 30 by an RF link, a fax 31b or a modem. The subscriber base unit 30 and subscriber terminal 31 may form an integral unit, such as a combined terminal and phone, or a digital cordless unit. FIG. 3 shows the subscriber base unit 30 supporting a plurality of terminals 31 which can inter act with similar terminals on PSDN or ISDN. However, a simple system may only support terminals for one type of network and/or only a single terminal.

The subscriber base unit 30 of this embodiment comprises an RF unit 34 for transmitting and received RF signals, a control unit 35 for controlling the base unit 30, a memory 36 for storing programmes, parameters and status mode data, an audio generator 37 for executing the mutual adaptation of the audio signals of the subscriber terminal 31 and the RF unit 34, a signal processor 38 for processing signals to and from the RF unit, a line interface 39 between the RF unit 34 and the subscriber terminal 31, a mode unit 40 for indicating which mode the base unit 30 is operating in (for example communications mode or installation mode) and a regulator 41 for providing supply voltages for the units of the subscriber base unit 30.

When a signal is received by the RF unit 34 it is amplified and demodulated into a baseband signal by the RF unit 34 and the baseband signal is then processed by a signal processor 38. Similarly, the transmitted baseband signal is converted into digital form and processed for transmission by the signal processor 38 according to the specifications of the cellular system and modulated into an RF frequency and amplified in the RF unit 34 for transmission to the base station 33a via the RF link 32. The signal processor 38 and RF unit 34 are controlled by the control unit 35.

The line interface 39 comprises a DTMF detector, a hook detector, a tone generator and a ringing generator. The DTMF detector detects dialling signals which are transferred to the control unit 35 and stored in memory 36. The hook detector detects the state of the hook switch of the subscriber terminal 31 and transmits the status mode data to the control unit 35 and to the tone generator. The tone generator forms audio signals according to the status of connection which is being transmitted by the cellular system. The ringing generator forms a high voltage ringing signal (for example 45 volts AC) for the ringing function of the terminal 31. The line interface unit may be a SLIC (subscriber line interface circuit) which is generally used, for example, in office switchboards. The SLIC circuit contains, on the same chip, adaptor circuits for adapting audio signals and signals formed by the aforementioned DTMF detector, hook detector, tone generator and ringing generator etc.

Alternatively, if the wireless local loop terminal equipment is intended to be connected to digital cellular systems, the audio generator 37 can, for example, be a separate PCM codec or convertor which has been generally used in ISDN telephones. In such a case, the line interface does not require a DTMF detector as this can be done by the audio generator 37.

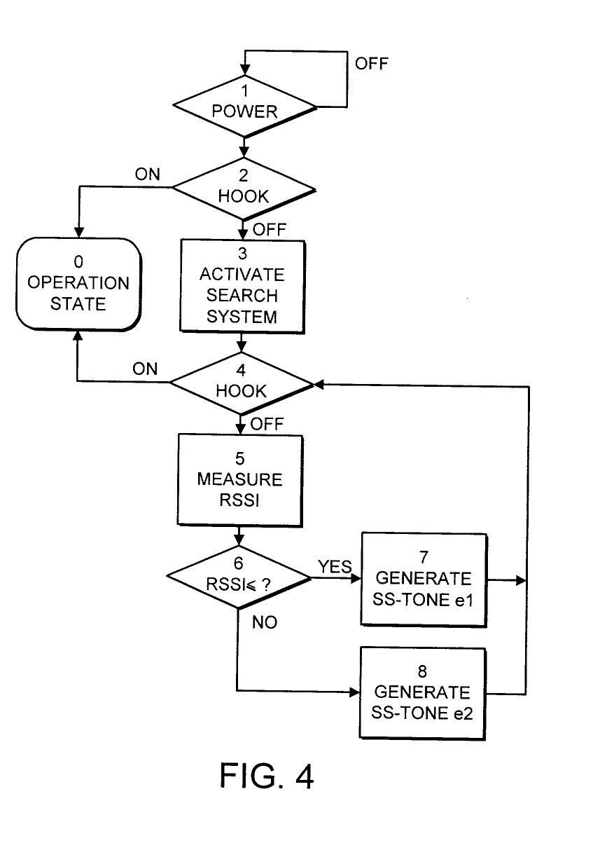

The communications system 30, 31 of the present invention has a special mode in which the user is given an indication of the quality of the RF link 32. This mode may, for example, be a special installation mode which enables optimum location of the base unit to be determined by the subscriber after purchase of the system. The base unit 30 may, for example, have a mode switch, which the user can operator to alter the mode of operation of the base unit, between normal communications mode and this special installation mode. Alternatively, the installation mode may be selected by operating the base unit 30 in a certain sequence, such as the sequence described with respect to FIG. 4 below.

The indication of the quality of the RF link 32 may be made by any means which can be detected by the user's senses. For example, the indication may be given on the display of a user terminal 31 or of the base unit 30. However, in the present embodiment the indication is an audible one which is provided using the loudspeaker of the user terminal 31. The audible indication may be, for example, a variation in frequency of an acoustic signal according to the quality of the RF link. That is, the frequency may increase with an increase in RF link quality. Alternatively, the audio indication may reside in the intensity of an acoustic signal. For example, the signal could get louder for an improved quality in the RF link.

In the present embodiment, the audible indication is obtained as follows. Firstly, the RF unit 34 measures the received network field strength and forwards a received signal strength indication (RSSI) to the control unit 35, which in turn, forwards it to the audio generator 37. Then, the audio generator determines the output of the loudspeaker by controlling the line interface 39 on the basis of the received signal strength indication. If the audible indication is to be a change in frequency, the audio generator controls the tone generator of the line interface, and if the audible indication is to be a change in intensity of the signal, then the audio generator controls the power of the signal sent to the user terminal.

As an alternative to using the loudspeaker of the user terminal, the indicator may be provided in a similar manner by the base unit if it comprises a loudspeaker.

Optionally the quality of the path of the RF link 32 from the subscriber communications system 30, 31 to the telecommunications network 33 is determined by the telecommunications network 33. The results are sent to the terminal by SMS or another signalling method.

An alternative or additional mode to the installation mode, in which the user is given an indication of the quality of the RF link is a network update mode. In this mode, it can be determined whether an installed base unit is in an appropriate position given the change in the network configuration (for example if base stations have been added, power levels adjusted etc.). The network update mode may be initiated by the network and the results reported to the user and/or the wireless local loop operator. As in the installation mode, the indication may be by any means which may be detected by the user's senses. The results may be displayed on a display of the subscriber base unit 30 or user terminal 31. Alternatively, an audible indication may be given. In this case, the presence or absence of a signal may be a sufficient indication. For example, if the present location of the base unit 30 is no longer able to obtain a signal of suitable quality, then an audible warning signal may be given via the loudspeaker of the terminal or base unit.

FIG. 4 is a flow chart showing the operation of the installation mode according to a preferred embodiment of the present invention. In this embodiment the base unit is switched to installation mode if the user terminal 31 is off-hook when the power of the base unit is turned on.

When in installation mode, the subscriber terminal equipment operates as follows:

Step 1: the base unit is waiting to be powered up

Step 2: power is supplied to the base unit 30, the base unit checks the state of the receiver of the user terminal 31. If the receiver is on-hook, the base unit operates in normal communications mode. If the receiver is off-hook when the base unit is powered up, then the base unit operates in installation mode.

Step 3: the subscriber system is switched into installation mode

Step 4: the state of the receiver (i.e. on-hook or off-hook) is checked

Step 5: if the receiver is still off-hook, the quality of the RF link is determined, by measuring the receive signal strength indication level

Step 6: the control unit 35 checks the RSSI level

Step 7: if the signal strength indication is below an acceptable level, then the audio generator 37 causes the tone generator of the line interface to generate a tone E1. The base unit continues determining the RSSI level until the receiver is back on-hook.

Step 8: if the RSSI level is acceptable, then the base unit causes a tone associated with the RSSI level to be generated, and again the base unit continues to determine the signal strength until the receiver is placed on-hook.

Typical value of acceptable RSSI level is 100 dbm. Example frequencies are a discontinuous beep at frequency 300 Hz for E1, with an RSSI of 100 dbm being at 500 Hz and a frequency slide of 500 Hz upward with every dbm increase for E2.

In view of the foregoing description it would be evident to a person skilled in the art that various modifications may be made within the scope of the claims. For example, an alternative search system to that shown in FIG. 4 can be implemented in various different ways. The RSSI signal can be indicated by a facsimile if a landline phone is not available. The base unit could send RSSI data to the fax machine which would operate as a printer. Also, the acoustic indicator may be a variation in sound intensity and/or frequency. The acoustic indicator can be activated by using a specified sequence (for example #??#) at the subscriber terminal. Also the installer can activate the installation mode merely when installing, and turning it off when the installation is completed.

What is claimed is:

1. A communications system comprising:
a subscriber terminal and an associated subscriber base unit for providing communication with a telecommunications network via an RF link, wherein the terminal or base unit is operable, in one mode, to signal to a user an indication of the quality of said RF link.

2. A system as claimed in claim 1, wherein the indication is an acoustic indication.

3. A system as claimed in claim 2, wherein the frequency of an acoustic signal varies according to the quality of said RF link.

4. A system as claimed in claim 2, wherein the intensity of an acoustic signal varies according to the quality of said RF link.

5. A system as claimed in claim 1, wherein the indication is a visual indication.

6. A system as claimed in claim 1, wherein the indication is a tactile indication.

7. A system as claimed in any preceding claim, wherein the quality of the path of the RF link from the telecommunications network to the subscriber base unit is determined by the subscriber base unit.

8. A system as claimed in any preceding claim, wherein the quality of the path of the RF link from subscriber base unit to the telecommunications network is determined by the telecommunications network.

9. A system as claimed in any preceding claim, wherein the quality of the path is determined by measuring the received signal strength.

10. A system as claimed in any preceding claim, wherein the subscriber terminal or base unit operates in said one mode in response to a signal from the telecommunications network.
